(19) United States
(12) Patent Application Publication
(10) Pub. No.: US 2011/0171435 A1
(43) Pub. Date: Jul. 14, 2011

(54) SINGLE SIDE STITCHING FOR INTERIOR SKINS

(76) Inventors: Mark Michael Sheldon, Shelby Township, MI (US); Russell James Morey, Ypsilanti, MI (US); John Gerard Quinn, Novl, MI (US)

(21) Appl. No.: 12/686,481

(22) Filed: Jan. 13, 2010

(51) Int. Cl. B32B 3/10; B29C 45/14; D05B 23/00; D05B 3/00

(52) U.S. Cl. 428/195.1; 264/273; 112/475.08; 112/475.17

(57) ABSTRACT

A skin assembly is disclosed. The skin assembly includes a skin formed from a material that is capable of being stitched, a thread passing through the skin to form a stitch pattern on a first surface of the skin and a loop extending from a second surface of the skin opposite the first surface, and a substrate coupled to the loop of the thread to secure the thread in the skin.

### FIELD OF THE INVENTION

The present invention relates generally to an interior skin for a vehicle. More particularly, the invention is directed to a stitched skin assembly and a method for stitching a skin.

### BACKGROUND OF THE INVENTION

The traditional application of real thread stitching for vehicle interior products has been performed by functionally attaching two separate skins products together at a visible seam joint. If executed properly this appearance provides the customer with a persona of highly crafted component. The execution of a real stitch using this traditional method is costly and requires special control and care to maintain acceptable quality in production. A recent development introduced in the industry involves stitching a single skin with an advanced robotic work cell. In this case a robot is stitching a skin that along a particular path to provide the appearance of a functional seam. This stitching method involves a needle carrying an upper thread through a top surface of the skin and looping the upper thread through a bottom surface of the skin. A looper is used to lock a loop of the upper thread with a lower thread to create a knot adjacent the bottom surface. This step prevents the thread from pulling out of the appearance side of the part. When applied, this robot stitching method addresses the cost and quality concerns of traditional stitching.

However, the stiffness of a conventional formed skin limits a surface geometry that can be stitched. The current skins for components disposed in an interior of a vehicle have limitations on a location of a stitch and placement of a seam line due to the nature of the formed skin and the current stitching processes. These limitations constrain customer styling and can degrade the appearance and authenticity of the final product.

It would be desirable to develop a stitched skin assembly and a method for stitching a skin, wherein the skin assembly and the method maximize a surface geometry that can be stitched while providing a desirable seam appearance on a visible surface of the skin assembly.

### SUMMARY OF THE INVENTION

Concordant and consistent with the present invention, a stitched skin assembly and a method for stitching a skin, wherein the skin assembly and the method maximize a surface geometry that can be stitched while providing a desirable seam appearance on a visible surface of the skin assembly, has surprisingly been discovered.

In one embodiment, a skin assembly comprises: a skin formed from a material capable of being stitched; a thread passing through the skin to form a stitch pattern on a first surface of the skin and a loop extending from a second surface of the skin opposite the first surface; and a substrate coupled to the loop of the thread to secure the thread in the skin.

In another embodiment, skin assembly comprises: a skin formed from a material capable of being stitched; a thread passing through the skin to form a stitch pattern on a first surface of the skin and a tufted loop adjacent a second surface of the skin opposite the first surface; and a substrate encapsulating at least a portion of the tufted loop of the thread to secure the thread in the skin.

The invention also provides methods for stitching a skin.

One method comprises the steps of: providing a skin formed from a material capable of being stitched; passing a thread through the skin to form a stitch pattern on a first surface of the skin and a tufted loop adjacent a second surface of the skin opposite the first surface; and securing the tufted loop to retain the stitch pattern on the first surface of the skin.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary cross-sectional view of a skin assembly according to an embodiment of the present invention;

FIG. 2 is a fragmentary cross-sectional view of the skin assembly of FIG. 1 including a substrate to form a skin assembly; and

FIG. 3 is a schematic block diagram of a method for stitching a skin according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

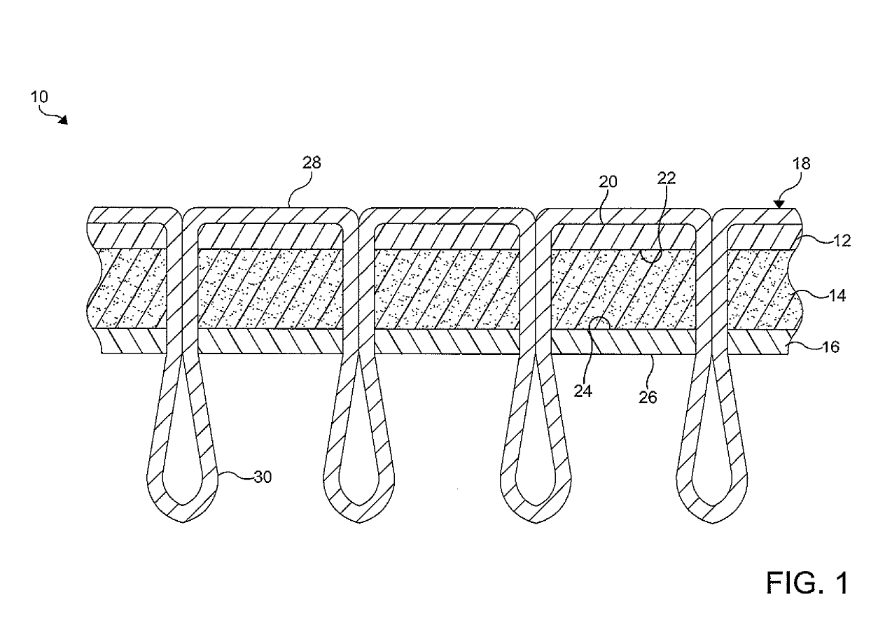

FIG. 1 illustrates a stitched skin 10 according to an embodiment of the present invention. As shown, the skin 10 is a tri-laminate skin having three layers 12, 14, 16 stitched with a thread 18. As a non-limiting example, the skin 10 is flexible but capable of maintaining a formed shape. It is understood that the skin 10 may have any number of layers, including one, for example. It is further understood that the skin 10 may be formed from any material that can be stitched with the thread 18.

A first layer 12, a top layer as shown, is formed from a thermoplastic olefin (TPO) material. The first layer 12 includes a first surface 20 and a second surface 22. However, the first layer 12 may be formed from any material capable of being stitched.

A second layer 14, a middle layer as shown, is disposed adjacent the second surface 22 of the first layer 12 and interposed between the first layer 12 and a third layer 16. As a non-limiting example, the second layer 14 is formed from a compressible material. In the embodiment shown, the second layer 14 is formed from a TPO foam. However, the second layer 14 may be formed from any material capable of being stitched.

The third layer 16, a back or bottom layer as shown, is formed from a polypropylene. However, the third layer 16 may be formed from any material capable of being stitched. The third layer 16 includes a first surface 24 and a second surface 26. In the embodiment shown, the first surface 24 of the third layer 16 is disposed adjacent the second layer 14.

The thread 18 is caused to extend through the layers 12, 14, 16 of the skin 10 using a tufting technique to form a stitch pattern 28 on the first surface 20 of the first layer 12 and a tufted loop 30 extending beyond the second surface 26 of the third layer 16.

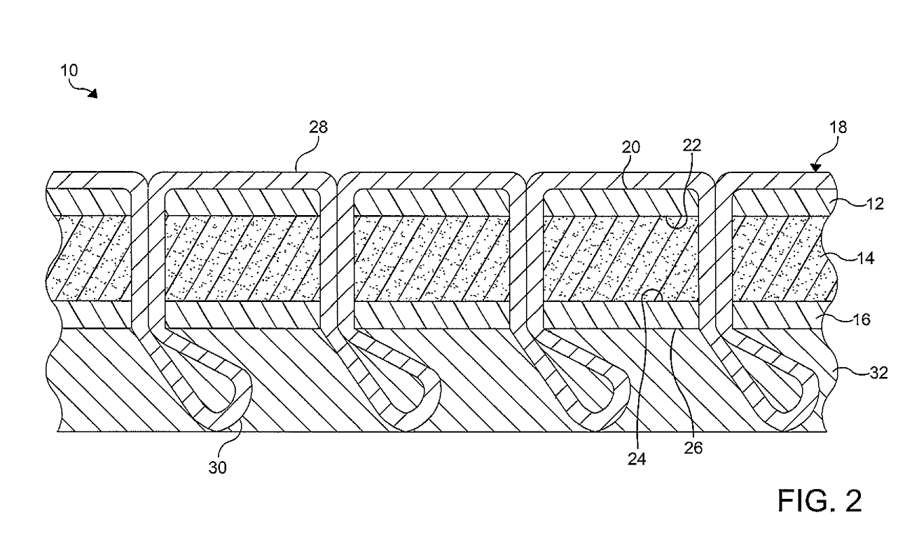

FIG. 2 illustrates the skin 10 having a substrate 32 disposed thereon to form a skin assembly. The skin 10 is typically disposed on the substrate 32 and coupled thereto to create a skin-covered component such as an instrument panel for an interior of a vehicle, for example. However, the skin 10 can be formed around any surface.

In the embodiment shown, the substrate 32 is formed from a TPO. As a non-limiting example, a molten TPO resin is back injected adjacent the second surface 26 of the third layer 16 of the skin 10 to encapsulate at least a portion of the thread 18 to secure the thread 18 therein. It is understood that the substrate 32 can be formed from any material. It is further understood that any means for securing the tufted loop 30 of the thread 18 in the skin 10 may be used. In certain embodiments, an additional substrate layer (not shown) is formed adjacent the substrate 32 to support or contain the substrate 32. As a non-limiting example, a thermoset foaming material can be injected adjacent the second surface 26 of the third layer 16 of the skin 10 to form the additional substrate layer.

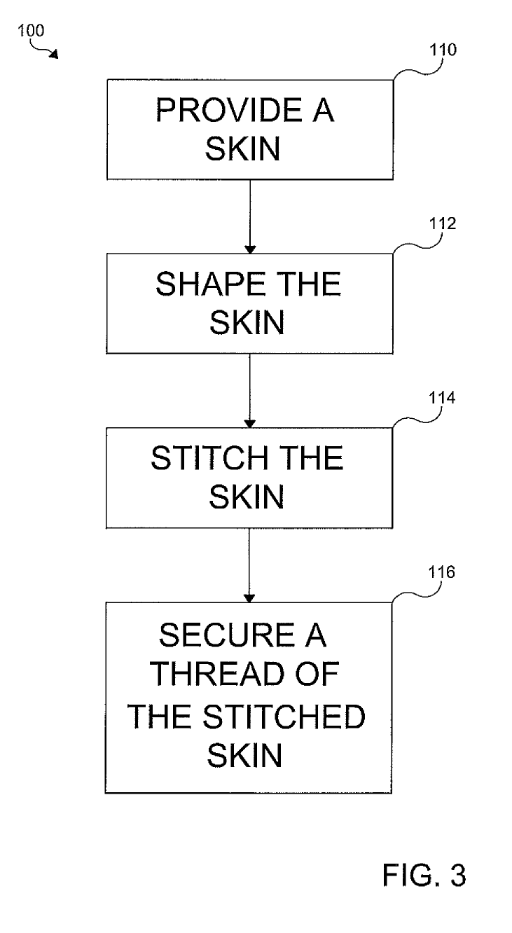

FIG. 3 illustrates a method 100 for stitching the skin 10 according to an embodiment of the present invention. Initially, the skin 10 is provided, as shown in step 110. As a non-limiting example, the skin 10 can be manufactured as a tri-laminate skin using methods known in the art. For example, the skin 10 can be formed using any skin formation method, including but not limited to a casting, a spraying, a negative vacuum forming, and a positive vacuum forming. However, any skin or skin assembly that is capable of being stitched can be used.

In step 112, the skin 10 is shaped to a pre-determined geometry. In certain embodiments, the skin 10 is flat and unformed. However, any geometry and shape can be used. As a non-limiting example, a seam line is formed in the first layer 12 of the skin 10 for guiding a stitching procedure and aligning the stitch pattern 28 on the first surface 20 of the first layer 12. It is understood that the seam line can be formed in any stitchable surface of the skin 10. It is further understood that the skin 10 can be with or without a real or a faux seam.

Once the skin 10 is formed into the desired shape, the thread 18 is stitched along the seam line using a tufting method, as shown in step 114. In other words, the thread 18 is stitched from the first surface 20 of the first layer 12 and the tufted loop 30 of the thread 18 extends beyond the second surface 26 of the third layer 16. Stitching of the thread 18 can be accomplished using any tufting method available.

In the embodiment shown, a three layer skin construction is chosen to provide good retention of the thread 18 to the skin 10 prior to the final process step of securing the thread 18.

In step 116, the formed and shaped skin 10 is placed in an injection mold cavity. The mold tool is closed and a molten TPO resin is injected adjacent the second surface 26 of the third layer 16 and around the tufted loop 30 of the thread 18. The TPO resin material solidifies and encapsulates the tufted loop 30 to lock the thread 18 in place. It is understood that the material used to encapsulate the tufted loop 30 can be any material that can secure the tufted loop 30. It is further understood that any process may be used to introduce a securing material to the thread 18 such as injection molding of a thermoplastic, injection of a thermoset material such as a polyurethane foam between an outer surface of the skin 10 and the additional substrate carrier, and an application of an adhesive to a surface of the skin 10 which is then bonded to the substrate 32 (or additional substrate carrier) to create the final skin assembly.

The skin 10 and the method 100 maximize a surface geometry that can be stitched while providing a desirable stitch pattern and seam appearance on a visible surface of the skin 10. The skin 10 and method 100 do not require a top and bottom stitching process and the thread 18 can be stitched through the skin 10 from a single side thereof, thereby maximizing the possible stitch locations on the skin 10.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A skin assembly comprising:
a skin formed from a material capable of being stitched;
a thread passing through the skin to form a stitch pattern on a first surface of the skin and a loop extending from a second surface of the skin opposite the first surface; and
a substrate coupled to the loop of the thread to secure the thread in the skin.

2. The skin assembly according to claim 1, wherein the skin is a composite skin having a plurality of layers.

3. The skin assembly according to claim 2, wherein at least one of the layers is formed from a thermoplastic olefin.

4. The skin assembly according to claim 2, wherein at least one of the layers is formed from a polypropylene.

5. The skin assembly according to claim 2, wherein at least one of the layers is formed from a compressible foam material.

6. The skin assembly according to claim 1, wherein the substrate is injection molded adjacent the second surface of the skin to encapsulate the loop therein.

7. The skin assembly according to claim 1, wherein the skin is shaped to a pre-determined geometry prior to the thread passing therethrough.

8. The skin assembly according to claim 1, wherein the skin includes a seam line for aligning the stitch pattern on the first surface of the skin.

9. A skin assembly comprising:
a skin formed from a material capable of being stitched;
a thread passing through the skin to form a stitch pattern on a first surface of the skin and a tufted loop adjacent a second surface of the skin opposite the first surface; and
a substrate at least partially encapsulating at least a portion of the tufted loop of the thread to secure the thread in the skin.

10. The skin assembly according to claim 9, wherein the skin is a composite skin having a plurality of layers.

11. The skin assembly according to claim 10, wherein at least one of the layers is formed from at least one of a thermoplastic olefin, a polypropylene, and a compressible foam material.

12. The skin assembly according to claim 9, wherein the substrate is injection molded adjacent the second surface of the skin to encapsulate the tufted loop therein.

13. The skin assembly according to claim 9, wherein the skin is shaped to a pre-determined geometry prior to the thread passing therethrough.

14. A method for stitching a skin, the method comprising the steps of:
providing a skin formed from a material capable of being stitched;
passing a thread through the skin to form a stitch pattern on a first surface of the skin and a tufted loop adjacent a second surface of the skin opposite the first surface; and
securing the tufted loop to retain the stitch pattern on the first surface of the skin.

15. The method according to claim 14, wherein the skin is a composite skin having a plurality of layers.

16. The method according to claim 15, wherein at least one of the layers is formed from at least one of a thermoplastic olefin, a polypropylene, and a compressible foam material.

17. The method according to claim 14, wherein the tufted loop is coupled to a substrate to secure the tufted loop thereto.

18. The method according to claim 17, wherein the substrate is injection molded adjacent the second surface of the skin to encapsulate at least a portion of the tufted loop therein.

19. The method according to claim 14, wherein the skin includes a seam line for aligning the stitch pattern on the first surface of the skin.

20. The method according to claim 14, wherein the skin is shaped to a pre-determined geometry prior to the thread passing therethrough.
